(19) United States
(12) Patent Application Publication
(10) Pub. No.: US 2010/0163792 A1
(43) Pub. Date: Jul. 1, 2010

(54) PROCESSES FOR PREPARING FERTILIZED EGG COMPONENTS

(75) Inventor: Jerald Bain, Toronto (CA)

Correspondence Address: WILMERHALE/BOSTON, 60 STATE STREET, BOSTON, MA, 02109, US

(73) Assignee: United Paragon Associates Inc., Guelph ,ON (CA)

(21) Appl. No.: 12/445,197

(22) PCT Filed: Oct. 12, 2007
(86) PCT No.: PCT/CA2007/001798

§ 371 Date: Mar. 4, 2010

Related U.S. Application Data
(60) Provisional application No. 60/851,085, filed on Oct. 12, 2006.
(60) Provisional application No. 60/952,331, filed on Jul. 27, 2007.

(51) Int. Cl. C09K 3/00

(52) U.S. Cl. 252/182.12

(57) ABSTRACT

The invention relates to processes for preparing fertilized egg components using freeze-drying and/or extraction methods.

### FIELD OF THE INVENTION

The invention relates to processes for preparing fertilized egg components using techniques such as freeze-drying and extraction methods.

### BACKGROUND OF THE INVENTION

Substance preparation techniques, such as extraction and freeze-drying techniques, are routinely used in various industries to isolate particular substances or components, or subsets thereof, and prepare them for storage, transport, or immediate use. It is desirable to improve and enhance such techniques in order to optimize such parameters as yield, purity, and storage suitability.

### SUMMARY OF THE INVENTION

In accordance with a first aspect of the invention, a process for preparing a powdered sample of the contents of at least fertilized egg is provided. The process comprises the steps of (i) substantially separating the contents of at least one fertilized egg from the shell; (ii) optionally filtering the contents to produce a solid or solid and semi-solid retentate, (iii) freezing the contents or retentate, (iv) freeze-drying the contents or retentate, (v) optionally, combining one or more freeze-dried contents or retentate, and (vi) pulverizing the contents or retentate to form a powder. Optionally, preservatives can be added to the powder.

In accordance with a second aspect of the invention, a process for producing a powdered aqueous extract from a slurry prepared according to embodiments of the present invention is provided. The process comprises the steps of (i) mixing the slurry with an aqueous solution for a period of time, (ii) clarifying the mixture to produce an aqueous solution substantially free of solid material, (iii) separating the aqueous solution from the solid material, (iv) freezing the aqueous solution, and (v) freeze-drying the aqueous solution to produce a powder. Optionally, preservatives can be added to the powder.

In accordance with a third aspect of the invention, a process for producing a concentrated solvent extract from a slurry prepared according to embodiments of the present invention is provided. The process comprises the steps of (i) mixing the slurry with a hydrophobic solvent for a period of time, (ii) clarifying the mixture to produce a solution substantially free of solid material, (iii) separating the solution from the solid material, (iv) separating the hydrophobic solvent portion from any aqueous solvent portion, and (v) concentrating the hydrophobic solvent portion.

In accordance with a fourth aspect of the invention, a process for preparing a powdered sample of at least one embryo is provided. The process comprises the steps of (i) substantially separating the at least one embryo from at least one fertilized egg; (ii) optionally washing the at least one embryo, (iii) freezing the at least one embryo, (iv) freeze-drying the at least one frozen embryo, and (v) pulverizing the at least one freeze-dried embryo to form a powder. Optionally, preservatives can be added to the powder. ‘Optionally, the embryo and some or all of the white albumen portion can be used, in which case the washing step can be modified or excluded.

In accordance with a fifth aspect of the invention, a process for producing a powdered aqueous extract from a slurry of at least one embryo, or at least one embryo and some or all of the white albumen portion, is provided. The process comprises the steps of (i) mixing the slurry with an aqueous solution for a period of time, (ii) clarifying the mixture to produce an aqueous solution substantially free of solid material, (iii) separating the aqueous solution from the solid material, (iv) freezing the aqueous solution, and (v) freeze-drying the aqueous solution to produce a powder. Optionally, preservatives can be added to the powder.

In accordance with an sixth aspect of the invention, a process for producing a concentrated solvent extract from a slurry of at least one embryo is provided. The process comprises the steps of (i) mixing the slurry with a hydrophobic solvent for a period of time, (ii) clarifying the mixture to produce a solution substantially free of solid material, (iii) separating the solution from the solid material, (iv) separating the hydrophobic solvent portion from any aqueous solvent portion, and (v) concentrating the hydrophobic solvent portion.

In accordance with a seventh aspect of the invention, a process for producing a slurry of all or part of the contents of at least one fertilized egg is provided. The process comprises the steps of (i) substantially separating the contents of at least one fertilized egg from the shell; (ii) optionally filtering the contents to produce a retentate, (iii) combining the contents or retentate in a container, (iv) blending, optionally with solvent added, the contents or retentate to produce a slurry, (v) optionally freezing the slurry to save for further processing. Optionally, the contents of more than one fertilized egg can be combined during the filtration process, in which case step (iii) is optional.

### BRIEF DESCRIPTION OF THE FIGURES

The person skilled in the relevant arts will understand that the figures, described below, are for illustration purposes only. The figures are not intended to limit the scope of the invention in any way.

FIG. 1 is a photograph of an embryo removed from an egg according to embodiments of the present invention.

FIG. 2 is a photograph of a freeze-dried embryo according to embodiments of the present invention.

FIG. 3 is a photograph of freeze-dried embryos according to embodiments of the present invention.

FIG. 4 is a photograph of pulverized freeze-dried embryo according to embodiments of the present invention.

FIG. 5 is a photograph of a slurry of a number of embryos according to embodiments of the present invention.

### DETAILED DESCRIPTION OF THE INVENTION

In accordance with an aspect of the invention, a process for preparing a powdered sample of at least one embryo or preparing a powdered sample from a portion or all of the contents of a fertilized egg is provided. At least one fertilized egg is incubated for anywhere from about 3 to about 15 days, more preferably about 3 to about 5 days, or more preferably about 6 to about 12 days, and even more preferably about 7 to about 9 days, from the day the egg is fertilized. Generally speaking, the fertilized egg is incubated for a period of time that allows angiogenesis to initiate and/or the embryo to mature to the point that embryos are visible to the naked eye. The eggs can be from a variety of origins, for example, avian, reptilian, or from egg-laying mammals. Generally speaking, any egg from which an embryo or blood vessels associated with an embryo can be removed can be suitable. The eggs are preferably avian eggs, and can be obtained from any bird that has been bred for egg production, such as chicken, geese, ducks, and the like. Chicken eggs are preferred for reasons including their availability and ability to be mass produced. Incubation can occur in any environment, so long as the eggs are kept at a temperature for extended periods of time that allows maturation of the embryo. Suitable temperatures for incubation are in the range of about 20° C. to about 60° C., more preferably in the range of about 25° C. to about 55° C., and more preferably in the range of about 35° C. to about 45° C. Once the eggs are incubated for a period of time, they are optionally treated to reduce external microflora or otherwise sterilized by any suitable means, such as washing the egg shells with a solvent such as ethanol, for example, an about 50 to about 95% solution of ethanol, with subsequent time allowed to allow evaporation or drying of the solvent, or by rotating the eggs under an ultraviolet (UV) light source for a suitable period of time. Any solvent is preferably evaporated before further manipulation of the egg. The eggs are then cracked to access the inner contents. The eggs can be cracked under aseptic conditions either manually or using a suitable mechanical device. This procedure and/or all or most of the procedures described above and below can be conducted in a cooled atmosphere, such as an atmosphere of about 5° C.

According to one aspect of the invention, the contents of the egg are collected in a container, such as a stainless container, which is preferably sterilized and/or chilled. The contents from the container or from the egg can optionally be subjected to a filtration process, for example, by being placed on a mesh. The mesh openings can be about 0.5 to about 4 millimeter, more preferably about 1 millimeter. The mesh is preferably sterile. Optionally, the contents of the egg and/or some or all of the broken shell can be placed directly on the mesh. The contents of the egg and/or some or all of the broken shell are allowed to filter on the mesh for a period of time such that there is substantially no further dripping of fluid through the mesh. The broken shell can be removed from the contents of the egg before, during, or after the filtration process. After the filtration, the solid or solid and semi-solid retentate can comprise the embryo, a substantial portion or all of the yolk, vascular connective tissue, a substantial portion or all of the albumen, a substantial portion or all of the chalaza, and the clear sac if it has not broken. Semi-solid retentate can comprise solid material as well as a viscous material, such as a gelatinous material, for example, albumen. The retentate or semi-solid retentate can be optionally washed at least once with a suitable solvent, such as a buffer solution, sterile deionized water, or any suitable saline solution. For example, sterile phosphate buffer solution (PBS) can be used.

The retentate can be collected from one egg and then freeze-dried according to the processes described herein.

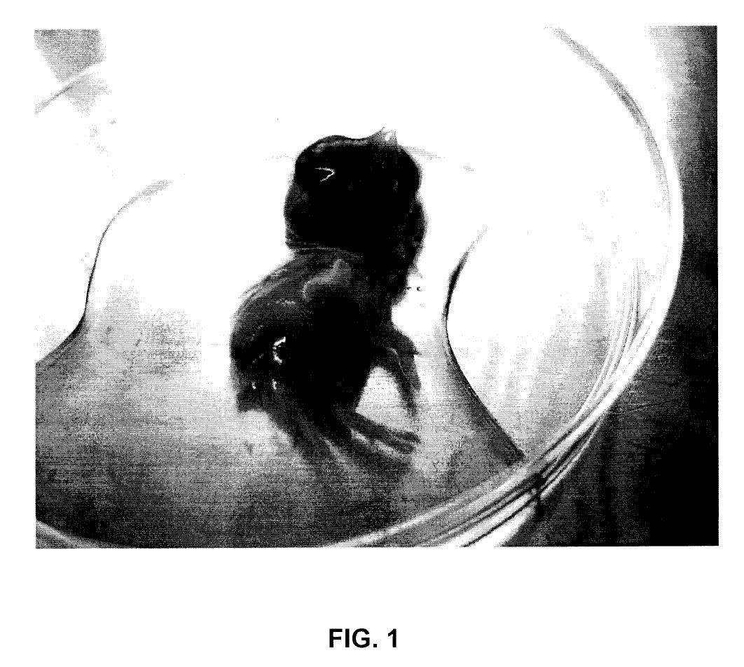

According to another aspect of the invention, the white albumen portion and embryo can be substantially separated from the rest of the contents of the egg. The white albumen portion may be substantially separated from the rest of the contents by any suitable means, such as decantation of the white albumen portion, or by suction. The embryo can be substantially separated from the white albumen portion manually or other suitable means as determined by the skilled person. FIG. 1 shows an example of an embryo that was removed from an egg and washed with buffer. It will be recognized by those skilled in the art that the embryo can be substantially separated from the white albumen portion and the rest of the inner contents at the same time. For example, the embryo can be manually removed from the white albumen portion and rest of the inner contents using tweezers or other suitable instrument. In some cases, the embryo can be manually peeled off the yolk sac, which forms part of the rest of the inner contents.

Once the embryo is substantially separated from the white albumen portion and the rest of the inner contents of the egg, the embryo is optionally washed at least once with a suitable solvent, such as a buffer solution, sterile deionized water, or any suitable saline solution. For example, sterile phosphate buffer solution (PBS) can be used.

It will be understood for the following methods that reference to contents of the egg may actually be a reference to the retentate if the contents have been subjected to a filtration process. It will also be understood that a whole fertilized egg can be cracked, the shell removed, and the whole of the shelled egg frozen and freeze-dried according to any of the procedures described above and below. Also, more than one whole fertilized egg can be cracked, shells removed, the whole of the shelled eggs combined and blended into a slurry, and frozen and freeze-dried according to any of the procedures described above and below.

The contents of the eggs or the embryos are placed in at least one freezable container. The container can be, for example, a test tube, Petri dish, beaker, stainless steel tray, or plastic container.

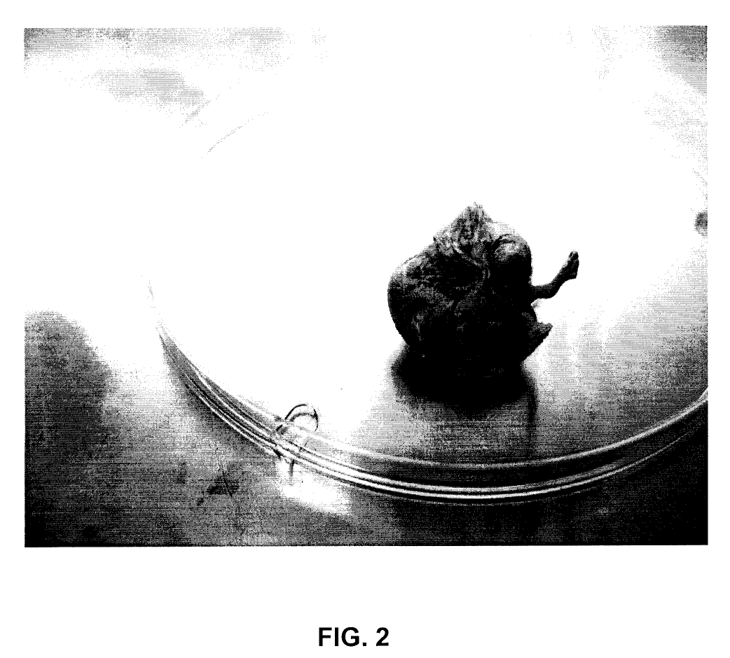

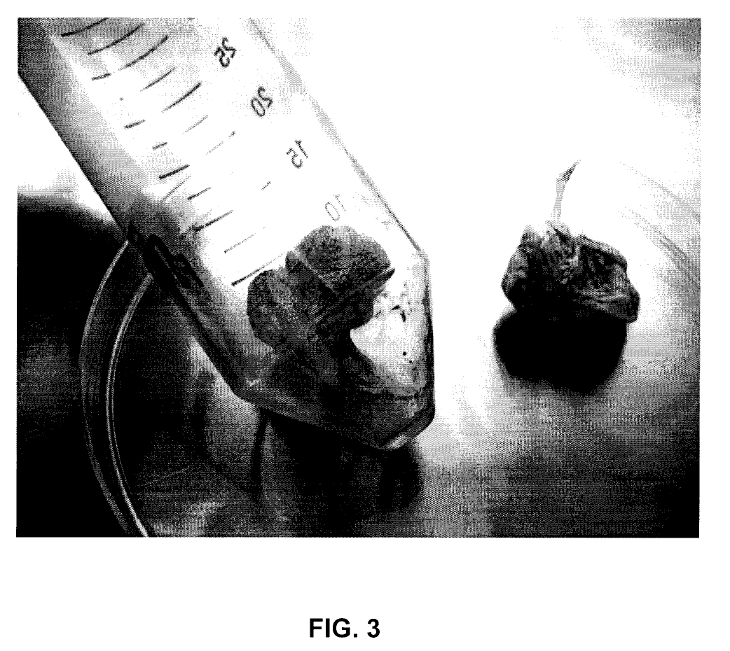

It is preferred that the contents or embryos are frozen very soon after being removed from the shell, such as within about 2 hours, more preferably within about 1 hour, and even more preferably within about 0.5 hours, or as soon as possible. Depending on how long the contents or embryos are to be frozen, the freezing temperature should be in the range of about −50° C. to about 10° C., more preferably in the range of about −40° C. to about 5° C., and even more preferably in the range of about −35° C. to about −25° C. It is preferred that the contents or embryos are frozen for at least about 6 hours, more preferably at least about 12 hours, even more preferably at least about 24 hours. The frozen contents or embryos may be freeze-dried or lyophilized after a period of time. The contents or embryos can be completely frozen before the freeze-drying/lyophilizing step. FIGS. 2 and 3 show examples of embryos after they have been freeze-dried. Freeze-drying is preferably performed at an ultimate temperature in the range of about −80° C. to about −10° C., more preferably in the range of about −65° C. to about −15° C., and even more preferably in the range of about −40° C. to about −20° C. and a pressure of about 500 millitorr, or other suitable pressure as can be determined by the skilled person. The freeze-drying process is preferably maintained at the ultimate temperature for a period of in the range of about 1 to about 6 hours, more preferably in the range of about 2 to about 5 hours, and even more preferably in the range of about 3 to about 4 hours. The whole freeze-drying process is typically conducted for a period in the range of about 15 to about 45 hour, more typically in the range of about 25 to about 35 hours, and even more typically in the range of about 28 to about 32 hours.

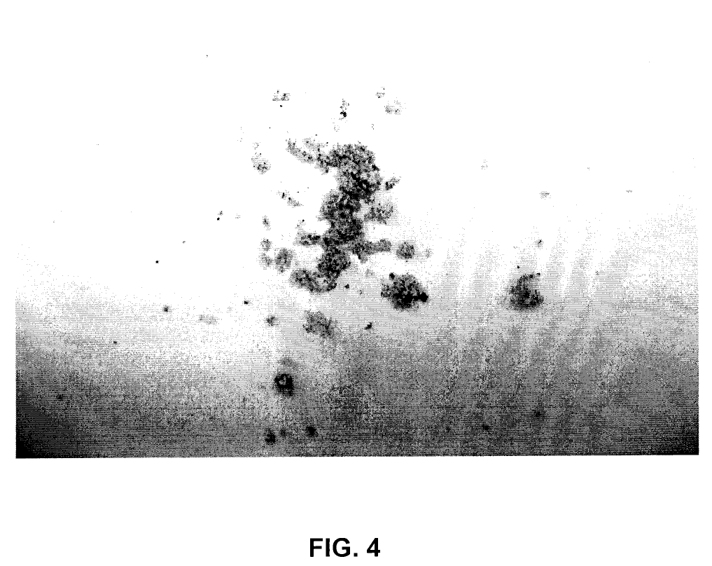

In accordance with another aspect of the invention, the freeze-dried contents or freeze-dried embryo is dispersed and/or pulverized if necessary to form a substantially homogeneous powder. The contents that were freeze-dried individually or in smaller groups can be combined together before or after the pulverization step to form a substantially homogeneous powder. The pulverization can be done, for example, mechanically using a suitable machine, such as a coffee bean grinder or a hammer mill, or manually using a suitable tool, such as a glass rod. FIG. 4 shows an example of pulverized freeze-dried embryo. The powder is optionally sterilized before being stored and/or used. A suitable sterilization should be one that does not adversely affect certain freeze-dried components. For example, in some cases, the sterilization method can comprise irradiation of the powder.

Preservatives to control microbial growth can be blended into powders produced by the processes disclosed herein before it is stored. Suitable preservatives include common food preservatives such as 0.5% w/w sodium benzoate and 0.2% w/w potassium sorbate. Other suitable preservatives could be selected by the skilled person.

The powders produced by the processes disclosed herein can be stored in suitable, substantially air-tight containers. Suitable containers include plastic bags, barrels, plastic containers, bottles, combinations thereof, and the like. For example, the powder can be packaged under controlled, aseptic conditions into sterile polyethylene/polypropylene bottles with tamper-proof security seals. The powder can be stored under a substantially dry, inert gas, such as nitrogen. It is preferred that the powder be stored at room temperature or cooler, for example, at a temperature in the range of about 10° C. to about 25° C., more preferably in the range of about 15° C. to about −20° C. For long term storage, it is preferred that the powder is stored at a temperature of about −10° C. or below, or, more preferably, −20° C. or below. The powder can be stored for a period of time in a substantially desiccated atmosphere. The powder can also be vacuum-packed.

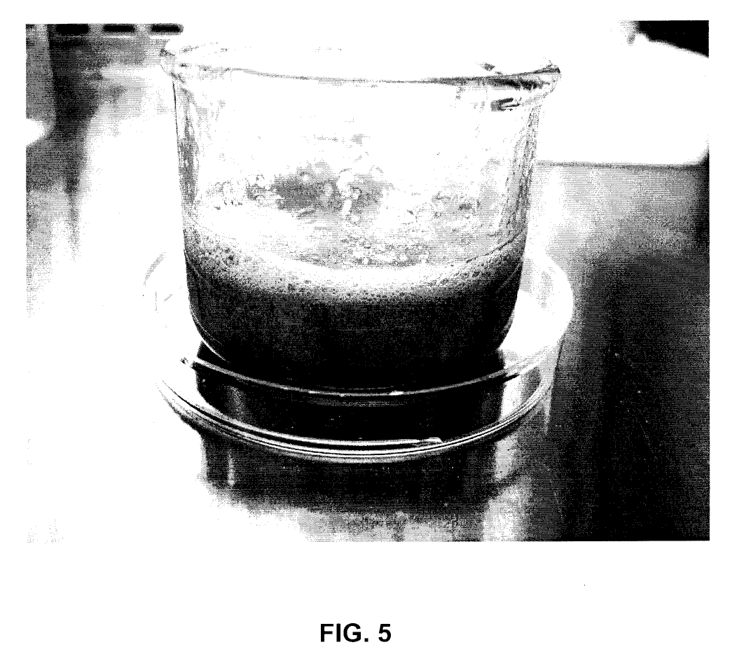

In accordance with another embodiment of the present invention, frozen or unfrozen contents or embryos can be pooled in a suitable container, such as a beaker, or a plastic container, and mixed or blended with a suitable solvent, if necessary, to form a slurry. The separated contents or embryos can be cooled during a portion or all of this step. For example, the container can be placed on ice to facilitate cooling. The solvent should be suitably aqueous to wet the mixed contents or embryos and be able to be frozen in a standard laboratory freezer. Suitable solvents include water, aqueous buffer, and the like. The contents or embryos can be blended or homogenized with, for example, a hand-held blender or other suitable means. FIG. 5 shows an example of a container of a slurry of embryos. The slurry can be partially or wholly used for extraction procedures as follows or frozen for further processing.

An aqueous extraction procedure can be performed by mixing the slurry with an aqueous solution for a period of time. The aqueous solution may comprise water, an aqueous buffer, or any other aqueous solvent. If the aqueous solution comprises water, it is preferred that the water is distilled and, more preferably, also deionized before use. For example, the water can be treated to reverse osmosis (R.O.). The slurry and the aqueous solution can be mixed, for example, by stirring for a period of time, the period of time being in the range of about 5 to about 60 minutes, more preferably in the range of about 10 to about 45 minutes, and even more preferably in the range of about 15 to about 40 minutes. It is desired that the aqueous solution has sufficient exposure to the contents of the slurry so that any substantially hydrophilic molecules in the solution are dissolved in the aqueous solution. The aqueous solution can be of a substantially equal volume to the slurry, but volumes of 1.5 times, 2 times, or even 3 times the volume of the slurry can be used. Optionally, the mixture can be warmed slightly during the mixing step. After the mixing, the aqueous solution can be substantially clarified by substantially removing any solid portions in the mixture by suitable means such as centrifugation or filtration. The clarified aqueous portion can then be frozen and freeze dried to produce a powder that is optionally sterilized according to methods described herein.

According to another aspect of the invention, the slurry produced by any of the methods described above can be mixed with a substantially hydrophobic solvent. The substantially hydrophobic solvent is preferably chilled. Suitable hydrophobic solvents include, for example, ether, chloroform, hexane, petroleum ether, or acetonitrile. For example, ether, especially diethyl ether, can be used. The slurry is mixed with the hydrophobic solvent for a period of time as described above. As will be recognized by a person skilled in the relevant arts, any steps of a process using a substantially hydrophobic solvent should be conducted in a fume hood or similar device, and the solvents should be kept away from open flames or heat sources. After the mixing period, the solid portions of the mixture can be substantially removed from the solvent portion by suitable means such as centrifugation or filtration. The solvent portion will comprise substantially a hydrophobic solvent portion and may also comprise an aqueous portion. The solvent portion can be transferred to a separating funnel or essentially equivalent device to separate the aqueous portion from the hydrophobic solvent portion. In the case of ether, the top layer is the hydrophobic solvent portion. The ether-based portion can be siphoned off the top or removed from the separating funnel after the bottom aqueous layer is removed. Alternatively, the bottom aqueous portion can be frozen, thereby allowing the top ether-based layer to be decanted. The aqueous portion can be extracted a number of times, for example, about 3 times, with the hydrophobic solvent. The hydrophobic solvent can be of substantially equal volume to the aqueous portion, or can be 1.5 times, 2, times or even 3 times the volume of the aqueous solvent. After the extraction process, all of the hydrophobic extracts are pooled and concentrated by a suitable method. The concentrated extracts can be stored at a temperature below room temperature, such as about 5° C. in a suitable container that is substantially sealed from the atmosphere, such as a sealed vial.

According to another aspect of the invention, a slurry produced by any of the methods described above can be clarified before an extraction procedure. Preferred clarification steps include methods of filtration, using such filters as sieves or filter papers or pads. Other clarification steps can include methods of centrifugation. A filter aid, such as Superflow DE™ can be added to the filtrate produced by the filtering step before further clarification. Some of the resultant filtrate can be frozen in suitable containers for freeze-drying. Also, some of the resultant filtrate can be mixed with a hydrophobic solvent as described above so that an aqueous layer and a hydrophobic layer are formed. The layers can be separated, concentrated, and stored as described herein.

Still other objects and advantages of the present invention will become readily apparent to those skilled in the art from the detailed description, wherein only the preferred embodiments are described, simply by way of illustration of the best mode contemplated of carrying out the invention. As will be realized, the invention is capable of other and different embodiments, and its several details are capable of modification in various obvious respects, such as an obvious re-ordering of steps, all without departing from the invention. Accordingly, the description and examples below are to be regarded as illustrative in nature, and not as restrictive.

### Examples

### Example 1

Fertilized hen eggs that were 8-9 days old were selected. The whole egg was disinfected with 70% ethanol and left in the fume hood to allow the 70% ethanol to evaporate. The eggs were broken and the contents were dropped through a sterile 1.0 mm mesh. The shells and filtrate were discarded. The retentate, both solid and liquid, was collected and chilled on ice. The retentate was homogenized at 5° C. The homogenate (slurry) was poured into sterile stainless steel trays, frozen, for further processing.

### Example 2

Chicken embryos were harvested at 8 days old from fertilized hen eggs according to the following method:

(i) 24 brown eggs were received;

(ii) when cracked open, only 22 of 24 eggs where found fertilized containing the developed embryo (91.6% fertilization rate);

(iii) embryos were removed and washed (×2) briefly in sterile PBS and immediately frozen at −20° C. in individual 50 mL (milliliter) test tubes;

(iv) 10 test tubes were then freeze dried in a freeze dryer (shelf temp.=−40° C., condenser temp. −52° C.);

(v) at the end of the cycle, the individual embryos (while in test tube) were crushed with a sterile glass rod and the resulting powder (1.7 g (grams)) was packaged for irradiation;

(vi) The finished powder was stored at 2-8° C. (short term) or −20° C. (long term). The 12 remaining embryos were pooled in a small beaker and blended with a small amount of water using a hand-held blender.

### Results

Once dried, the powder (1.7 g) was dispersed and made homogeneous using a glass rod and prepared for irradiation=Lot#EM200601. Each embryo yields 0.17 g powder. The dried slurry (1.6 g) was dispersed and made homogeneous using a glass rod and prepared for irradiation=Lot#EM200602. Each embryo yields 0.14 g powder (moisture unknown).

### Example 3

Sixty fertilized eggs (8 day old embryos) were received. The following is a description of the preparation of both the aqueous and the ether extracts.

All eggs were sprayed with 70% (v/v) ethanol to sterilize the external surface and the eggs were left in the laminar flow hood for the alcohol to evaporate. The eggs were broken and the embryos and the attached clear sac with its clear watery content were carefully separated from the rest of yolk and vascular material. Then, all material, that is, the embryo and clear sacs, was pooled in a beaker that had been chilled on ice. Following the harvest, the material was blended with a help of the hand held blender that resulted in a slurry.

The resulting slurry (approx. 200 mL) was split into two equal halves; one was used for extraction with water and the second for ether extraction.

Aqueous Extract

To the 100 mL slurry, 100 mL of R.O. water was added and the material was stirred at room temperature for 30 minutes. The material was clarified by centrifugation and the aqueous top layer was collected (200 mL 1.1% solids). The aqueous top layer was then frozen and subsequently freeze dried. The dry powder=1.0 g, was labeled EM200603 and sterilized by irradiation.

Ether Extract

To 100 mL of the slurry, 100 mL of previously chilled ether was added. The mixture was shaken at room temperature and then subjected to centrifugation. At the end of the centrifugation period (15 minutes at 5° C.), the top aqueous/ether layer was transferred to a separating funnel and the top ether layer was collected either by siphoning or, after a period of freezing at −20° C. that froze the lower turbid aqueous layer, leaving the top clear yellow ether layer unfrozen, was decanted.

The lower aqueous layer was extracted again with an equal volume of ether as described above and the process was repeated three times. The ether extract was then concentrated and dried in the Rotavap™ to a small volume (approximately 1 mL). The sample was kept at 5° C. and no further processing was needed before shipping. The sample was labeled EM200604.

### Example 4

Due to a need for 10× amount of aqueous extract (EM200603) and 5× volume of ether extract (EM200604) sent earlier, a larger number of eggs was needed. Four hundred twenty fertilized eggs (8-9 day old embryos) were received. The following is a description of the preparation of both the aqueous and the ether extracts.

All eggs were sprayed with 70% (v/v) ethanol to sterilize the external surface as much as possible and the eggs were left in a fume hood for the alcohol to evaporate. The eggs were broken (62 out of 420 were found unfertilized, fertilization rate=85.2%) and the embryos and their attached clear sac with its clear watery content were carefully separated from the rest of yolk and vascular material and all material, that is, the embryo and clear sacs, was pooled in a beaker that had been chilled on ice. The harvested material (approx. 2 L) was kept at 5° C. until used a day after receipt.

Aqueous Extract

Following the harvest, the material was blended with a hand-held blender that produced a slurry. The resulting slurry (approx. 2 L) was passed through a metal sieve (MESH no. 20). The filtrate was further clarified with a paper filter pad and DE 6000. The cake left on the filter pad was discarded. To the filtrate, Superflow DE™ was added and the material was further clarified by passing through a filter pad. All filtration was done using a Buchner funnel at bench scale level. The majority (about 1200-1300 mL) of the resulting filtrate was separated and immediately frozen in trays for freeze drying (1.9% solids). The remaining 500 mL was mixed with an equal volume of previously chilled ethyl ether in a 1 L bottle and kept at 5° C. until separation of the two layers. The dried powder was labeled EM200605 and irradiated.

Ether Extract:

To 500 mL of the slurry, 500 mL of previously chilled ether was added, the mixture shaken at room temperature and then subjected to centrifugation. At the end of the centrifugation period (15 minutes at 5° C.) the top aqueous/ether layer was transferred to a separating funnel and the top ether layer was collected either by siphoning or after a period of freezing at −20° C. that will freeze the lower turbid aqueous layer, leaving the top clear yellow ether layer to be decanted.

The lower aqueous layer was extracted again with 300 mL of ether as described above and the extracts were pooled in a round-bottom, previously chilled flask. The ether extract was then concentrated and dried in the Rotavap™ to a small volume. The sample was kept at 5° C. and no further processing was needed before shipping. The sample was labeled EM200606.

The above described embodiments of the invention are merely descriptive of its principles and are not to be considered limiting. Further modifications of the invention herein disclosed will occur to those skilled in the respective arts and all such modifications are deemed to be within the scope of the invention as defined by the following claims.

What is claimed is:

1. A process for preparing a powdered sample of all or part of the contents of at least fertilized egg, the process comprising the steps of (i) substantially separating the contents of at least one fertilized egg from the shell; (ii) optionally filtering the contents to produce a solid or solid and semi-solid retentate, (iii) freezing the contents or retentate, (iv) freeze-drying the contents or retentate, (v) optionally, combining one or more freeze-dried contents or retentate, and (vi) pulverizing the contents or retentate to form a powder.

2. The process according to claim 1, further comprising adding preservatives to the powder.

3. A process for producing a slurry of all or part of the contents of at least one fertilized egg, the process comprising the steps of (i) substantially separating the contents of at least one fertilized egg from the shell; (ii) optionally filtering the contents to produce a retentate, (iii) combining the contents or retentate in a container, (iv) blending, optionally with solvent added, the contents or retentate to produce a slurry, (v) optionally freezing the slurry to save for further processing.

4. A process for producing a powdered aqueous extract from a slurry prepared according to claim 3, the process comprising the steps of (i) mixing the slurry with an aqueous solution for a period of time, (ii) clarifying the mixture to produce an aqueous solution substantially free of solid material, (iii) separating the aqueous solution from the solid material, (iv) freezing the aqueous solution, and (v) freeze-drying the aqueous solution to produce a powder.

5. The process according to claim 4, further comprising adding preservatives to the powder.

6. A process for producing a concentrated solvent extract from a slurry prepared according to claim 3, the process comprising the steps of (i) mixing the slurry with a hydrophobic solvent for a period of time, (ii) clarifying the mixture to produce a solution substantially free of solid material, (iii) separating the solution from the solid material, (iv) separating the hydrophobic solvent portion from any aqueous solvent portion, and (v) concentrating the hydrophobic solvent portion.

7. The process according to claim 6, wherein the hydrophobic solvent is ether.

8. A process for preparing a powdered sample of at least one embryo is provided, the process comprising the steps of (i) substantially separating the at least one embryo from at least one fertilized egg; (ii) optionally washing the at least one embryo, (iii) freezing the at least one embryo, (iv) freeze-drying the at least one frozen embryo, and (v) pulverizing the at least one freeze-dried embryo to form a powder.

9. The process according to claim 8, further comprising adding preservatives to the powder.

10. A process for producing a powdered aqueous extract from a slurry of at least one embryo, or at least one embryo and some or all of the white albumen portion, the process comprising the steps of (i) mixing the slurry with an aqueous solution for a period of time, (ii) clarifying the mixture to produce an aqueous solution substantially free of solid material, (iii) separating the aqueous solution from the solid material, (iv) freezing the aqueous solution, and (v) freeze-drying the aqueous solution to produce a powder.

11. The process according to claim 10, further comprising adding preservatives to the powder.
